(19) United States
(12) Patent Application Publication
(10) Pub. No.: US 2026/0030367 A1
(43) Pub. Date: Jan. 29, 2026

(54) Creation of Environment Information

(71) Applicant: Siemens Aktiengesellschaft, München (DE)

(72) Inventors: Christian Peter Feist, München (DE); Stefan Pyka, Markt Schwaben (DE); Thomas Zeschg, München (DE); Rainer Falk, Erding (DE)

(73) Assignee: Siemens Aktiengesellschaft, München (DE)

(21) Appl. No.: 18/993,179

(22) PCT Filed: Jul. 5, 2023
(86) PCT No.: PCT/EP2023/068535

§ 371 Date: Jan. 10, 2025

(30) Foreign Application Priority Data
Jul. 12, 2022 (EP) 22184343.6

(51) Int. Cl. G06F 21/60; H04L 9/32

(52) U.S. Cl. CPC G06F 21/602; H04L 9/3247

(57) ABSTRACT

Various embodiments include an application program to be executed in an execution environment. An example application program comprises: a documentation unit to create environment information describing the execution environment at a runtime of the application program; and an attestation unit to cryptographically protect the environment information forming a piece of attestation information.

### CROSS-REFERENCE TO RELATED APPLICATIONS

This application is a U.S. National Stage Application of International Application No. PCT/EP2023/068535 filed Jul. 5, 2023, which designates the United States of America, and claims priority to EP Application Serial No. 22184343.6 filed Jul. 12, 2022, the contents of which are hereby incorporated by reference in their entirety.

### TECHNICAL FIELD

The present disclosure relates to industrial processes. Various embodiments of the teachings herein include application programs, execution environments, control units, and methods.

### BACKGROUND

Due to the increasing degree of networking in industrial applications, as well as the need to process larger amounts of data locally for optimizing manufacturing processes, industrial devices are designed to be increasingly flexible with regard to their functionality. This is made possible in particular by the support of subsequently loadable applications, also referred to as applications or apps, with which the device functionality can be easily and quickly adapted even in the field.

The aim of this is to offer the customer the widest possible range of apps. Apps from different vendors can run on one device. The environment in which an app runs can therefore vary greatly, in particular having a plurality of different apps that are also running, base operating system variants and/or hardware. The properties of the execution environment of an app can therefore be critical to how trustworthy the data provided by an app is. In an industrial environment, this is important when an app is to be given access to critical data, or when the results of an app are to be taken into account in a decision, in particular to adjust a control logic.

Compliance checks and attestation mechanisms are generally used to draw conclusions as to the integrity of the software running on a computer platform. These are provided by the platform and are often complicated or inflexible to use, as they may be proprietary solutions from hardware manufacturers and/or are subject to dependencies on the infrastructure of hardware manufacturers.

A process known as “remote attestation” is known, in particular in connection with Measured Boot and a Trusted Platform Module (TPM). In this process, based on a “root-of-trust”, a cryptographic checksum is calculated for each boot component by a “root-of-trust-for-measurement” component. The checksums can then be stored, for example, in a TPM in special registers, so-called Platform Configuration Registers (PCRs), in which a PCR register is updated depending on the determined checksum. The list of PCR values can also be signed with a private key stored in the TPM that cannot be extracted, and then forwarded along with the signature to another entity (e.g. a server) for review. The access by the device to a service, or in general to a network, can thus be controlled according to the measured boot components.

Trusted Execution Environments (TEE) represent a specially protected execution environment that is only accessible from the regular execution environment (‘normal world’) via a well-defined interface. This can prevent, for example, a local system administrator or a piece of malicious software (malware), which is present in the regular execution environment, from manipulating program execution in the TEE execution environment. Examples of TEEs are Intel SGX, Intel TDX, AMD SEV, ARM TrustZone. Some of these technologies, such as Intel SGX, Intel TDX, and AMD SEV, provide a hardware-assisted way to certify the status of the software loaded into a TEE. With an issued attestation, the integrity and authenticity of the loaded software can be checked by a user and then a secret (e.g. key for decrypting a file system of the software running in the TEE) can be transferred to the software in the TEE. It is known from some implementations such as Intel SGX that the attestation functionality is realized by specific launch program code provided by the hardware manufacturer which is executed in a hardware-protected enclave (i.e. that the Intel enclave forms the attestation for the user enclave).

AMD SEV and Intel TDX are known in principle to assign different randomly selected keys to different virtual machines or containers, which are used for memory encryption of virtual machine data. This enables cryptographic isolation of a virtual machine from a compromised host as well as from other virtual machines.

A wide range of obfuscation methods are used to make code difficult for human beings to understand and thus to prevent reverse engineering or changes to the code useful for an attacker. There are also numerous obfuscation tools available that apply obfuscating transformations to a program largely automatically. This is usually done either on the basis of the source code or starting from the fully compiled and linked machine code of an application.

“Verifiable Computing” is a technique where calculations are outsourced to potentially untrusted systems and produce a verifiable result as part of the calculation. The verifiable result can be used to verify whether the calculation was performed correctly as intended. Exemplary and known implementations are based on homomorphic encryption or obfuscation, or on multiple calculation on different systems.

SafetyNet is a service provided by Android. The aim of SafetyNet is to enable critical apps (e.g. banking or payment apps) to check the status of the device before using it, in order to minimize potential misuse. The device collects data about the state of the device (e.g. whether Verified Boot is active or has been deactivated), which can be both evaluated on the server side and provided to an app via an API. For example, an app can determine whether the device has been modified and, if necessary, limit its functions or deny its execution.

### SUMMARY

The teachings of the present disclosure include application programs for execution in an execution environment. For example, some embodiments include an application program (A), designed to be executed in an execution environment, the application program having: a documentation unit, designed to create environment information, wherein the environment information describes the execution environment at a runtime of the application program (A), and an attestation unit, designed to cryptographically protect the environment information, whereby a piece of attestation information is formed.

In some embodiments, the application program (A) includes an output unit, designed to output the attestation information.

In some embodiments, the attestation information also comprises additional information.

In some embodiments, the environment information describing the execution environment at the runtime of the application program (A) relates to: hardware of the execution environment and/or an infrastructure of the execution environment and/or further application programs (A) of the execution environment and/or an operating system of the execution environment and/or a device and/or a system on which the execution environment is implemented, a file of the execution environment and/or a property of the execution environment and/or data relating to processor registers of the execution environment or of a system superordinate to the execution environment and/or configuration data of the application program (A) and/or configuration data of a peripheral module of the execution environment or of a system superordinate to the execution environment, and/or configuration data of an extension module of the execution environment or of a system superordinate to the execution environment, and/or data from access operations by the application program (A) to components of the execution environment or to a system superordinate to the execution environment and/or a performance measurement of the execution environment and/or cryptographic key accessible by the application program (A) and/or a security token accessible by the application program (A) and/or a digital certificate accessible by the application program (A).

In some embodiments, the environment information is formed as a fingerprint of the execution environment.

In some embodiments, the fingerprint (FP) of the execution environment comprises: a cryptographic checksum and/or a cryptographic hash value and/or an aggregated hash value.

In some embodiments, the application program (A) includes a checking unit, designed to check the environment information and/or the attestation information.

In some embodiments, the attestation unit is designed to cryptographically protect the environment information by means of a cryptographic signature, whereby the attestation information is formed.

In some embodiments, the attestation unit is designed to form the cryptographic signature by adding a secret, whereby the attestation information is formed, the secret being formed in particular as a private key or a symmetric key.

In some embodiments, the attestation unit is designed to protect the environment information by means of an obfuscated cryptographic protection mechanism, whereby the attestation information is formed.

In some embodiments, the application program (A) includes a memory function, designed to initiate the storage of the attestation information.

In some embodiments, the documentation unit is designed to create the environment information: during the runtime of the application program (A) and/or retrospectively to the runtime of the application program (A).

As another example, some embodiments include an execution environment comprising an application program (A) as described herein.

As another example, some embodiments include a control unit (AC, R I/O) having an execution environment as described herein.

As another example, some embodiments include a method for forming a piece of attestation information of an application program (A), wherein the application program (A) is executed in an execution environment, the method comprising: creating (S1) environment information, wherein the environment information describes the execution environment at a runtime of the application program, and cryptographically protecting (S2) the environment information, whereby a piece of attestation information is formed.

### BRIEF DESCRIPTION OF THE DRAWINGS

Some special features and advantages of various embodiments of the teachings herein are described in the following explanations of exemplary embodiments using schematic drawings. In the drawings:

FIG. 1 shows a schematic representation of an example application program incorporating teachings of the present disclosure in an execution environment of a control unit; and

FIG. 2 shows a flowchart of an example method incorporating teachings of the present disclosure.

### DETAILED DESCRIPTION

The teachings of the present disclosure relates to application programs designed to be executed in an execution environment. An example includes an application program having: a documentation unit, designed to create environment information, wherein the environment information describes the execution environment at a runtime of the application program, and an attestation unit, designed to cryptographically protect the environment information, whereby a piece of attestation information is formed. The application program can also be referred to as an application or app.

The execution environment includes an environment of the application program. The application program is executed in this environment, i.e. it runs in this environment. The environment can therefore also be referred to as a runtime environment or execution environment. The environment information contains information that relates to this execution environment at a time when the application program is or was running, that is, at the runtime of the application program.

The attestation unit is designed to perform cryptographic protection of the environment information, also referred to as App-RTE-Fingerprint Information (with RTE=Run-Time Environment). This is carried out in particular by generating a digital signature, whereby a piece of cryptographically protected App-RTE fingerprint information is created, also referred to as cryptographically protected attestation information or attestation information.

An application program or app itself creates and provides a specially generated, cryptographically protected attestation via its execution environment. In particular, the app performs fingerprinting of its execution environment, i.e. it processes the raw information of the execution environment in advance, and then uses the attestation to confirm what kind of execution environment it is running in.

Teachings herein include an application program which creates a specially generated piece of attestation information in which it confirms the type of execution environment in which it is running and attests the result (as raw information or preprocessed as a fingerprint) in a cryptographically protected manner. An app can independently implement attestation functionality to confirm its runtime environment. It is not necessary for the runtime environment itself to support such attestation functionality, and that a corresponding security infrastructure is provided by the runtime environment provider and must be accessible.

In some embodiments, in which the environment information and the attestation information must be realized independently of any attestation functionality of the runtime environment, the environment information can be generated and protected by an app itself. The teachings may be used if the runtime environment is not designed to attest environment information.

An app developer can implement this independently without the need for a controlled ecosystem, where there are particularly strong dependencies on the hardware and infrastructure. Such a solution can therefore be implemented specifically for apps with increased security requirements on the trustworthiness of an execution environment (in particular for an onboarding/provisioning app, for an AI-based analysis of operating data, or whether sensitive design data or recipes of an app are transmitted).

The described approach may be easier to implement in an industrial environment than an attestation process as supported by currently known solutions. An app developer can implement it independently without the need for a controlled ecosystem that is subject to strong hardware and infrastructure dependencies. This offers a flexible mechanism with which a reliable conclusion can be drawn as to the type of environment in which the app is running.

Subsequently, the app-RTE attestation/attestation information can be checked by the other entity, in particular the user, and an action can be carried out depending on a result of the check, in particular, processing of data of the app, or provision of data or services to the app. The result of the attestation/attestation information can be used by a user in particular as part of an assessment by a cloud service as to whether an app should be given access to critical data, or whether the data received from an app can be regarded as sufficiently trustworthy for certain operations.

The attestation information can thus be verified and used by the user to decide whether the app should be granted access to certain data or services, whether further data of the app can be considered trustworthy, or whether a connection to the app should be able to be established or terminated. Furthermore, the app-RTE attestation information can also be analyzed for monitoring purposes and, if selected, persistently stored for audit purposes, particularly in a production database.

Furthermore, it is possible for a user to check the attestation information formed by the app itself for compliance with attestation formed by the runtime environment. This has the advantage for the user that increased reliability about the present type of execution environment can be achieved.

In some embodiments, the application program additionally comprises an output unit, designed to output the attestation information. The output unit is designed to carry out the provision of the cryptographically protected attestation information to another entity, in particular an app management server, a device management system, a remote server, or a shopfloor monitoring server, a cloud-based backend service and/or another app, etc.

In some embodiments, the attestation information also includes additional items of information. The attestation issued by the app itself contains additional information that is not included in an attestation issued by the runtime environment. This may be advantageous if the attestation issued by the runtime environment only confirms rough summary information, in particular: “Runtime environment integer”. The additional information may be formed as data which is processed by the app, data and/or services which the application program accesses and requests access to, or connections that are established to the app.

In some embodiments, the environment information describing the execution environment at the runtime of the application program relates to:
hardware of the execution environment and/or
an infrastructure of the execution environment and/or
further application programs of the execution environment and/or
an operating system of the execution environment and/or
a device and/or a system on which the execution environment is implemented,
a file of the execution environment and/or
a property of the execution environment and/or
data relating to processor registers of the execution environment or of a system superordinate to the execution environment and/or
configuration data of the application program, in particular config files for an application program which in particular contains privileges of the application program and/or
configuration data of a peripheral module of the execution environment or of a system superordinate to the execution environment, and/or
configuration data of an extension module, designed in particular as a PCIe, of the execution environment or of a system superordinate to the execution environment, and/or
data from access operations by the application program to components of the execution environment or to a system superordinate to the execution environment and/or
a performance measurement of the execution environment and/or
a cryptographic key accessible by the application program and/or
a security token accessible by the application program and/or
a digital certificate accessible by the application program.

Environment information that relates to the hardware of the execution environment comprises security-relevant information of the CPU, in particular microcode version, existing CPU security features such as Intel CET and its configuration (in particular activated/not activated), vulnerability to hardware-specific side-channel attacks such as in particular Spectre/Meltdown.

An item of environment information that relates to the infrastructure of the execution environment comprises a Linux container or a Trusted Execution Environment (TEE) such as an Intel SGX enclave or an AMD SEV-protected virtual machine. In addition, it relates to outputs of certain virtual files/kernel interfaces (procfs, sysfs, special system calls), which in particular provide information on whether the app is running in a virtual machine, in a TEE or in a container.

Environment information which relates to other application programs of the execution environment comprises existing software binaries, libraries, packages, configuration files (or their versions), including their configuration settings (in particular sysctl/kernel parameters).

Environment information which comprises an operating system of the execution environment includes information about a Linux or Windows host operating system.

Environment information which relates to a property of the execution environment includes:
information on the rough classification (Normal World vs. TEE), as well as on the more detailed description (container with reduced privileges) and/or
information about running processes or system services (in particular whether specific, security-critical processes such as a runtime integrity check, a logging service such as auditd etc., are running) and/or
information about open ports, network settings such as iptable rules, kernel routing tables.

Environment information that relates to a property of the execution environment can be obtained:
by means of data/resources that are only accessible in a TEE, such as in particular a key protected when setting up the platform and/or
by means of data on the availability of specific CPU instructions, which can only be run in a TEE such as Intel SGX.

Environment information which comprises configuration data of the application program relates to permissions of the app processes themselves, also referred to as configurations of app privileges, such as permitted system calls (system call whitelisting rules), Linux capabilities, SELinux domain/AppArmor profile. The execution environment is responsible for assigning and/or configuring app privileges (here the “data”).

An item of environment information which includes data from accesses by the application program relates to data:
from accesses performed in tests (system calls, network connections, access to peripheral components or other hardware components, due to performance measurements, accessible cryptographic keys, security tokens and digital certificates) and/or
from status information (hardware, software) from log messages (kernel-log).

In some embodiments, the environment information is formed as a fingerprint of the execution environment. The fingerprint can be referred to as a pre-processed version of the data from the environment. The data volume of the environment information may be reduced and meaningful parts in terms of the environment are selected from the data.

In some embodiments, the entire raw information about the nature of the execution environment or parts thereof, the values of certain configuration files, software or microcode version numbers, is transmitted in cryptographically protected form. In some embodiments, a fingerprint of the execution environment is formed and transmitted as in this embodiment variant.

In some embodiments, the fingerprint of the execution environment comprises:
a cryptographic checksum and/or
a cryptographic hash value and/or
an aggregated hash value.

The determined app-RTE information is formed as a digital fingerprint by calculating, in a preprocessing stage, in particular one or more cryptographic hash values of the information (in particular an aggregated hash value or a list of examined properties plus corresponding hash values of the determined properties).

In some embodiments, the application program additionally comprises a checking unit, designed to check the environment information and/or the attestation information. As an alternative or in addition to checking by the user, the calculated App-RTE fingerprint information is checked by the app itself and a result is generated (e.g. “App-RTE OK/NOK”, “App-RTE is a TEE”, etc.). This is carried out by using reference information (which is considered to be true) about the system's own runtime environment by the app itself.

In some embodiments, the attestation unit is designed to cryptographically protect the environment information by means of a cryptographic signature, whereby the attestation information is formed. In particular, the attestation unit is thus designed to cryptographically sign the environment information, whereby cryptographic protection is created and whereby an attestation information is formed. In some embodiments, the signature can be formed by another unit. As an alternative to the signature, an encryption, in particular with a symmetric key, can be carried out in order to create cryptographic confidentiality protection.

In some embodiments, the attestation unit is designed to protect the environment information by means of an obfuscated cryptographic protection mechanism, whereby the attestation information is formed. In particular, the attestation unit is thus designed to cryptographically protect the environment information in obfuscated form, whereby cryptographic protection is created and whereby a piece of attestation information is formed. The obfuscated information is in particular a routine and/or a function and/or cryptographic material, in particular a key and/or a signature function which are used to form the attestation information. In some embodiments, the obfuscation can be performed by another unit.

In some embodiments, for improved protection the fingerprint logic and/or the secret for the cryptographic protection can be obfuscated. This makes manipulation more difficult. This can result in improved protection of the mechanism, regardless of the execution environment.

In some embodiments, the attestation unit is designed to form the cryptographic signature by adding a secret, whereby the attestation information is formed, the secret being formed in particular as a private key or a symmetric key. For this purpose, a secret available to the app (a private key, or previously exchanged symmetric key) can be used for encrypting or generating a digital signature. In particular, if the secret is only available in a protected environment (TEE; e.g. Intel SGX Enclave, Intel TDX or an AMD SEV-protected virtual machine, Secure World of an ARM TrustZone implementation), this can also be used in particular as an indication/proof for the property “TEE” for describing the execution environment and as environment information.

In some embodiments, the application program additionally comprises a memory function, designed to initiate the storage of the attestation information. In particular, the memory function outputs a command for storing the attestation information in a memory unit. Furthermore, it is possible that the app stores the determined app-RTE information in cryptographically protected form, preferably by means of a platform key specific to the app instance. This has the advantage that a possibly complex fingerprinting of the app-RTE by the app does not need to be repeated, but only takes place during installation or on an initial startup or after an update, or on user request or when requested by a server or other authorized communication partner. This is a useful option especially when changes to the execution environment (or features of the execution environment) by an attacker are highly unlikely or difficult to carry out.

In some embodiments, the app-RTE attestation information can be provided to or deposited in a distributed database for persistent storage or confirmation, in particular in a distributed ledger database (blockchain), immediately or after a pre-processing stage (in particular encryption, anonymization/pseudonymization, conversion to a verifiable credential). This has the advantage that the app-RTE attestation information is deposited and stored in a protected form.

In some embodiments, the documentation unit is designed to create the environment information: during the runtime of the application program and/or retrospectively to the runtime of the application program. If the environment information is created retrospectively to the runtime of the application program, this comprises in particular creating the environment information after the occurrence of certain events, while the environment information nevertheless contains and describes these events. In addition, the environment information includes in particular information about other application programs in the runtime environment that are no longer present at the time the environment information is created.

Some embodiments include an execution environment having an application program as described herein. The execution environment, also referred to as app-RTE, is realized in particular by one of the following, or by a combination of the following elements:
a native Linux host system,
a container runtime environment (e.g. Docker or Podman),
a virtual machine, e.g. Qemu-KVM with Linux guest system,
a Trusted Execution Environment, e.g. Intel SGX, Intel TDX/MKTME, AMD SEV (cryptographic and logical isolation at the hardware level) with Linux guest system, ARM TrustZone environment (logical isolation at the hardware level).

Some embodiments include a control unit having an execution environment as described herein.

Some embodiments include a method for forming a piece of attestation information of an application program, wherein the application program is executed in an execution environment, the method comprising: creating environment information, wherein the environment information describes the execution environment at a runtime of the application program, and cryptographically protecting the environment information, whereby a piece of attestation information is formed.

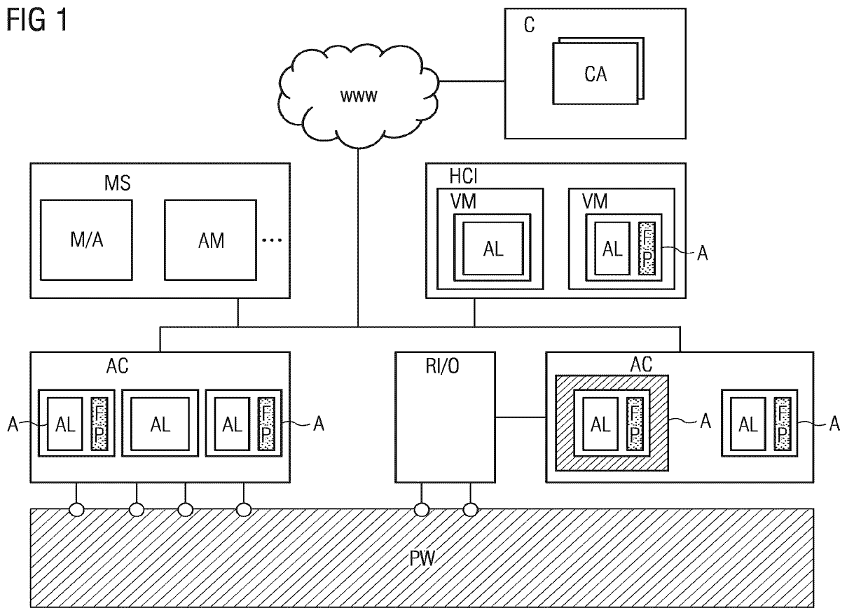

FIG. 1 shows a schematic representation of an example application program A incorporating teachings of the present disclosure in an execution environment of a control unit. The application program A is designed to be executed in an execution environment, comprising:
a documentation unit, designed to create environment information, wherein the environment information describes the execution environment at a runtime of the application program A, the environment information being formed in particular as a fingerprint of the execution environment, and
an attestation unit, designed to cryptographically protect the environment information, whereby a piece of attestation information is formed.

The application program A, also referred to as app A, consists of an app logic AL, also referred to as application logic, and in particular of a component for fingerprinting FP, also referred to as fingerprint logic FP. The component for fingerprinting FP is designed in particular as part of the documentation unit.

In an automation scenario, the application program A is executed on different control units AC and their runtime environments. In particular, the app A is executed on an automation component AC with control tasks, such as an industrial PC which is connected to a remote IO component R I/O, or on virtual machines as part of a Hyper-Converged Infrastructure System HCI, or on a Shopfloor server. The control units AC are connected to the real world PS, also referred to as the physical world PS.

The application programs A are downloaded via the Internet www from a cloud environment C and can thus also be referred to as cloud applications CA or cloud application programs.

The application programs A are managed via a Management Server MS. The Management Server MS has a monitoring and analytics component M/A and an app management component AM.

The unit provides one or more execution environments, also known as app-RTE, in which an app A can be run.

An app/application program A implements its own app-RTE fingerprinting logic FP. The fingerprinting logic FP is used by the app A at runtime to determine and process information and content of the app-RTE.

The processed information can be cryptographically protected by an attestation unit of the fingerprinting logic FP or the app logic AL. The result that characterizes the app-RTE is then transmitted. Both information on the rough classification (normal world vs. TEE) and on the more detailed description (container with reduced privileges) can be determined and processed.

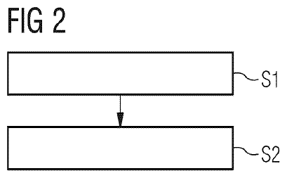

FIG. 2 shows a flowchart of an example method incorporating teachings of the present disclosure for forming attestation information of an application program, wherein the application program is executed in an execution environment, the method including:
Step S1: creating environment information, wherein the environment information describes the execution environment at a runtime of the application program, and
Step S2: cryptographically protecting the environment information, whereby a piece of attestation information is formed.

Although the teachings herein have been illustrated and described in greater detail by means of the exemplary embodiments, the disclosure is not restricted by the examples disclosed, and other variations can be derived therefrom by the person skilled in the art without departing from the scope of protection thereof.

What is claimed is:

1. An application program to be executed in an execution environment, the application program comprising:
a documentation unit to create environment information the execution environment at a runtime of the application program; and
an attestation unit to cryptographically protect the environment information forming a piece of attestation information.

2. The application program as claimed in claim 1, further comprising
an output unit to transmit the attestation information.

3. (canceled)

4. The application program as claimed in claim 1, wherein the environment information describing the execution environment at the runtime of the application program relates to at least one of:
hardware of the execution environment;
an infrastructure of the execution environment;
further application programs of the execution environment;
an operating system of the execution environment;
a device and/or a system on which the execution environment is implemented;
a file of the execution environment;
a property of the execution environment;
data relating to processor registers of the execution environment or of a system superordinate to the execution environment;
configuration data of the application program;
configuration data of a peripheral module of the execution environment or of a system superordinate to the execution environment;
configuration data of an extension module of the execution environment or of a system superordinate to the execution environment;
data from access operations by the application program to components of the execution environment or to a system superordinate to the execution environment;
a performance measurement of the execution environment;
a cryptographic key accessible by the application program;
a security token accessible by the application program; and/or
a digital certificate accessible by the application program.

5. The application program as claimed in claim 1, wherein the environment information comprises a fingerprint of the execution environment.

6. The application program as claimed in claim 5, wherein the fingerprint of the execution environment comprises:
a cryptographic checksum;
a cryptographic hash value; and/or
an aggregated hash value.

7. The application program as claimed in claim 1, further comprising
a checking unit to check the environment information and/or the attestation information.

8. The application program as claimed in claim 1, wherein the attestation unit cryptographically protects the environment information fusing a cryptographic signature, whereby the attestation information is formed.

9. The application program as claimed in claim 8, wherein the attestation unit forms the cryptographic signature by adding a secret, whereby the attestation information is formed, the secret comprising a private key or a symmetric key.

10. The application program as claimed in claim 1, wherein the attestation unit protects the environment information using an obfuscated cryptographic protection mechanism, whereby the attestation information is formed.

11. The application program as claimed in claim 1, further comprising
a memory function to initiate storage of the attestation information.

12. The application program as claimed in claim 1, wherein the documentation unit creates the environment information:
during the runtime of the application program; and/or
retrospectively to the runtime of the application program.

13. An execution environment comprising an application program to be executed in an execution environment, the application program comprising:
a documentation unit to create environment information describing the execution environment at a runtime of the application program; and
an attestation unit to cryptographically protect the environment information forming a piece of attestation information.

14. (canceled)

15. A method for forming a piece of attestation information of an application program to be executed in an execution environment, the method comprising:
creating environment information describing the execution environment at a runtime of the application program; and
cryptographically environment protecting the environment information and forming a piece of attestation information.
